(19) United States
(12) Patent Application Publication
(10) Pub. No.: US 2013/0253908 A1
(43) Pub. Date: Sep. 26, 2013

(54) Method and System For Predicting Words In A Message

(71) Applicants: Shumin Zhai, Los Altos, CA (US); Ciprian Ioan Chelba, Palo Alto, CA (US); Lawrence Diao, Vienna, VA (US)

(72) Inventors: Shumin Zhai, Los Altos, CA (US); Ciprian Ioan Chelba, Palo Alto, CA (US); Lawrence Diao, Vienna, VA (US)

(73) Assignee: GOOGLE INC., Mountain View, CA (US)

(21) Appl. No.: 13/455,707

(22) Filed: Apr. 25, 2012

Related U.S. Application Data
(60) Provisional application No. 61/614,614, filed on Mar. 23, 2012.

(51) Int. Cl. G06F 17/27

(52) U.S. Cl. 704/9

(57) ABSTRACT

A method may include receiving a context comprising data that is indicative of one or more characters input by a user at the first computing device, sending information comprising at least a portion of the context and determining a first predicted word based at least in part on the context. The determining may be based at least in part on a local language model. The method may include receiving a second predicted word from a second computing device within a time period. The second predicted word may be determined based at least in part on the context and a remote language model, and the local language and the remote language model may be different. The method may include identifying one of the first predicted word and the second predicted word as a final predicted word, and outputting the final predicted word at a display.

### CROSS-REFERENCE TO RELATED APPLICATION

This application claims priority to U.S. Provisional Application No. 61/614,614, filed on Mar. 23, 2012, the disclosure of which is incorporated herein by reference in its entirety.

### BACKGROUND

Modern text input methods typically require large amounts of memory and processing power to statistically process text input according to a language model. Although more memory and processing power generally increases the accuracy of input prediction and power of correction, mobile devices often have limited memory with which to host very large language models. A server-based solution may alleviate the memory and processing power constraints, but the time delay that occurs in waiting for a response from a remote server often makes a pure server-based approach an unreliable text input solution.

### SUMMARY

In an embodiment, a method may include receiving, at a first computing device, a context comprising data that is indicative of one or more characters input by a user at the first computing device, sending, by the first computing device to a second computing device, information comprising at least a portion of the context and determining, by the first computing device, a first predicted word based at least in part on the context. The determining may be based at least in part on a local language model. The method may include receiving a second predicted word from the second computing device within a time period. The second predicted word may be determined based at least in part on the context and a remote language model, and the local language and the remote language model may be different. The method may include identifying one of the first predicted word and the second predicted word as a final predicted word, and outputting the final predicted word at a display in communication with the first computing device.

In various embodiments, the information that is sent may include context-related information, which may include one or more of an identity of an application being used, an identity of a user of the first computing device, a location associated with the first computing device when the receiving occurs, and a time of day associated with the location when the receiving occurs. According to various embodiment, determining a first predicted word may include determining a first predicted word based on at least a portion of the context-related information.

In various embodiments, sending information may include sending at least a portion of the context to a second computing device located remotely from the first computing device. The remote language model may be more complex than the local language model.

In various embodiments, identifying one of the first predicted word and the second predicted word as a final predicted word may include identifying, from between the first predicted word and the second predicted word, the predicted word having a greater probability value as determined by the language model that predicted each respective predicted word.

In various embodiments, the time period may not exceed 0.5 seconds.

In various embodiments, outputting the final predicted word at a display of the first computing device may include outputting the final predicted word following the context at the display and/or outputting the final predicted word as part of a plurality of suggested words.

In various embodiments, a second context may be received at the first computing device, information including at least a portion of the second context may be sent, by the first computing device to the second computing, and the second predicted word may be output at the display in place of the final predicted word if the second predicted word is received at the first computing device from the second computing device within a second time period.

In various embodiment, one or more of the local language model and the remote language model are personalized to the user.

In an embodiment, a method may include receiving, at a first computing device, a context comprising data that is indicative of one or more characters input by a user at the first computing device, and sending, by the first computing device, information comprising at least a portion of the context to (a) a second computing device comprising a remote language model and to (b) a module on the first computing device, the module comprising a local language model. The local language and the remote language models may be different language models, and the local language model and the remote language model may be configured to return one or more predicted words based on a received context. The method may include receiving, by the first computing device, one or more predicted words from one or both of the local language model and the remote language models, and displaying at least a subset of the receiving predicted words at a display in communication with the first computing device, wherein the subset excludes words receiving after an event.

In some embodiments, at least a subset of the received predicted words may be filtered based on, at least in part, one or more characters input by a user at the first computing device and received by the first computing device after the sending occurs.

In various embodiments, an event may include the expiration of a time period and/or receiving one or more characters at the first computing device from a user after the sending occurs. In some embodiments, the time period may not exceed 0.5 seconds. In some embodiments, the subset may include a single word. In alternate embodiments, the subset may include at least two words, and the first computing device may include a user interface configured to detect a user selection of a word from the at least two displayed words.

In various embodiments, one or more predicted words received from the local language model may be displayed prior to receiving a response from the remote language model. The display may be updated using the one or more predicted words received from the remote language model provided that the one or more predicted words from the remote language model are received prior to the event.

In some embodiments, the second predicted word may be output at the display in place of the final predicted word if the second predicted word is received by the first computing device from the second computing device after expiration of the time period and a second probability value associated with the second predicted word exceeds a first probability value associated with the first predicted word.

In various embodiments, information including at least a portion of the context may be sent to a second computing device located remotely from the first computing device, and the remote language model may be more complex than the local language model. In some embodiments, the local language model and/or the remote language model may be personalized to a user.

In an embodiment, a method may include receiving, at a mobile computing device, a context comprising data that is indicative of one or more characters, input by a user at the mobile computing device, sending, by the first computing device to a server, information comprising at least a portion of the context, and analyzing, by one or more processors of the first computing device, at least a portion of the context using a first language model to provide a first set of predicted words based on at least a portion of the context. The first set of predicted words may include one or more words for the context. The method may include displaying the first set of predicted words on a display of the first computing device, receiving, at the mobile computing device, a second set of words from the server, and updating the display of the first computing device using the second set of words. The second set of words may include one or more words provided by a second language model used by the server to predict words based on the portion of the context sent by the mobile device.

In various embodiments, a second set of words may be received from the server prior to expiration of a time period. In some embodiments, a second set of words may be received from the server prior to the occurrence of an event, such as, for example, receiving, by a mobile computing device, a character input by a user.

In some embodiments, a probability value may be received for each word of the second set of words, and at least one word of the second set of words may be associated with a probability value greater than any word in the first set of words.

In various embodiments, information including at least the two words that were most recently input to the mobile computing device by a user may be sent to a server. In some embodiments, the first language model and the second language model may be different, and the second language model may be more complex than the first language model.

In an embodiment, a system may include a processor, a communication interface in communication with the processor, and a processor-readable storage medium in communication with the processor and the communication interface. The processor-readable storage medium may include one or more programming instructions that, when executed, cause the processor to receive a context comprising data that is indicative of one or more characters input by a user, send information comprising at least a portion of the context via the communication interface, and determine a first predicted word based at least in part on the context. The determining may be based at least in part on a local language model. The processor-readable storage medium may include one or more programming instructions that, when executed, cause the processor to receive a second predicted word within a time period, identify one of the first predicted word and the second predicted word as a final predicted word, and output the final predicted word at a display of the processor. The second predicted word may be determined based at least in part on the context and a remote language model. The local language model and the remote language model may be different.

In some embodiments, one or more programming instructions that, when executed, cause the processor to send information including at least a portion of the context may include one or more programming instructions that, when executed, cause the processor to send the information including at least a portion of the context to a computing device located remotely from processor. In various embodiments, the remote language model may be more complex than the local language model.

In some embodiments, one or more programming instructions that, when executed, cause the processor to determine a first predicted word may include one or more programming instructions that, when executed, cause the processor to analyze the context using the local language model. The local language model may stored in a non-transitory computer-readable storage medium located at the processor.

In various embodiments, one or more programming instructions that, when executed, cause the processor to identify one of the first predicted word and the second predicted word as a final predicted word may include one or more programming instructions that, when executed, cause the processor to identify from between the first predicted word and the second predicted word the predicted word having a greater probability value as determined by the language model that predicted each respective word.

In some embodiments, one or more programming instructions that, when executed, cause the processor to output the final predicted word at a display of the processor may include one or more programming instructions that, when executed, cause the processor to output the final predicted word following the context at the display and/or output the final predicted word as part of a plurality of suggested words.

### BRIEF DESCRIPTION OF THE DRAWINGS

FIG. 1 illustrates a system for predicting one or more words according to an embodiment.

FIG. 2 illustrates a method of predicting one or more words in a message according to an embodiment.

FIGS. 3A-3C illustrate examples of messages and predicted words that may be displayed in a local computing device according to some embodiments.

FIG. 4A and FIG. 4B illustrate examples of predicted words that may be displayed according to some embodiments.

FIG. 5 illustrates a block diagram of hardware that may be used to contain or implement program instructions according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

The embodiments described in this document relate to predicting one or more words of a message composed using a local computing device. A computing device may be an electronic device that includes a processor and a memory and which performs one or more operations according to one or more programming instructions. Examples of suitable local computing devices include mobile phones, personal digital assistants, tablet computers, portable computers, and the like. A local computing device may have, be connected to and/or be in communication with a display and an input device, such as, without limitation, a keyboard or a touch screen. A user of a local computing device may compose a message by entering one or more characters using an input device of a local computing device. For example, a user may enter one or more characters by pressing one or more buttons associated with the characters of a keyboard of a local computing device. As another example, a user may touch one or more representations of characters on a touch screen of a local computing device by, for example, using their fingers or a stylus.

In an embodiment, a message may be an electronic representation of alpha-numeric text. A message may include, without limitation, a text message, a Short Message Service (SMS) message, a Multimedia Message Service (MMS) message, an email, a word processing application, a social network message or posting and the like.

In an embodiment, one or more words in a message may be predicted. In an embodiment, one or more words that follow a context may be predicted. A predicted word or words may be determined based on a context in a message. For example, a predicted word or words may be determined based on a structure of the context, a frequency with which a previous word or words have historically been used by a user and the like. For example, if a message includes the context “I am playing”, predicted words may include, for example, “baseball”, “golf” or “hooky.”

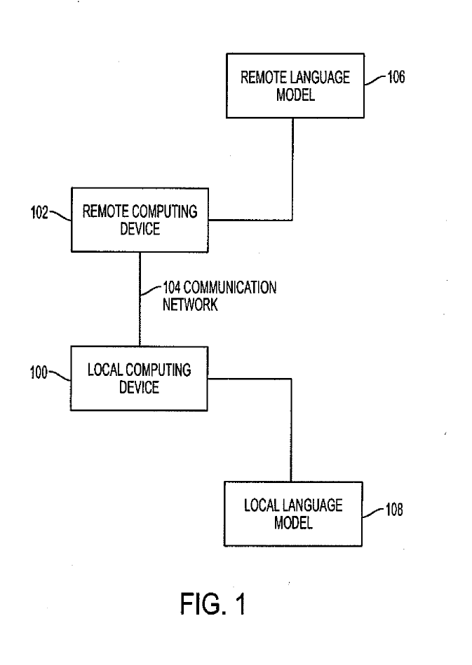

A local computing device may be in communication with a remote computing device. FIG. 1 illustrates an example of a system for predicting one or more words in a message according to an embodiment. As illustrated by FIG. 1, a local computing device 100 may be in communication with a remote computing device 102 via one or more communication networks 104. A communication network 104 may be a local area network (LAN), a wide area network (WAN), a mobile or cellular communication network, an extranet, an intranet, the Internet and/or the like. In an embodiment, a communication network 104 may provide communication capability between a remote computing device and a local computing device.

A remote computing device 102 may be a cloud computing device or a networked server located remotely from a local computing device 100. A remote computing device 102 may store a remote language model 106. In an embodiment, a remote computing device may store a remote language model, or at least a portion of a remote language model, in a local computer-readable storage medium, a local database, a remote computer-readable storage medium in communication with a remote computing device and/or another computer-readable storage medium.

A local computing device 100 may store a local language model 108. In an embodiment, a local computing device 100 may store a remote language model, or at least a portion of a remote language model, in a module of the local computing device, a local computer-readable storage medium, a local database, a remote computer-readable storage medium in communication with the local computing device and/or another computer-readable storage medium. A module may be a component of a larger system, such as a local computing device. A module may be implemented in software, hardware or a combination of hardware and software. In some embodiments, the local language model may differ from the remote language model.

A language model may define a probability mechanism for predicting a word or words. A language model may include words and/or sequences of words and probabilities associated with the words and/or sequences of words. The probabilities may indicate a likelihood that the word or word sequence is the next word or word sequence that will be entered. In an embodiment, a language model may be used to analyze properties of a language and predict one or more words in a sequence given one or more previous words in the sequence. Example approaches to language models are described in Foundations of Statistical Natural Language Processing by Christopher D. Manning and Hinrich Schutze, MIT Press, Jun. 18, 1999 and Speech and Language Processing, 2^{nd} Edition by Daniel Jurafsky and James H. Martin, Pearson Education, Limited, Jun. 28, 2000.

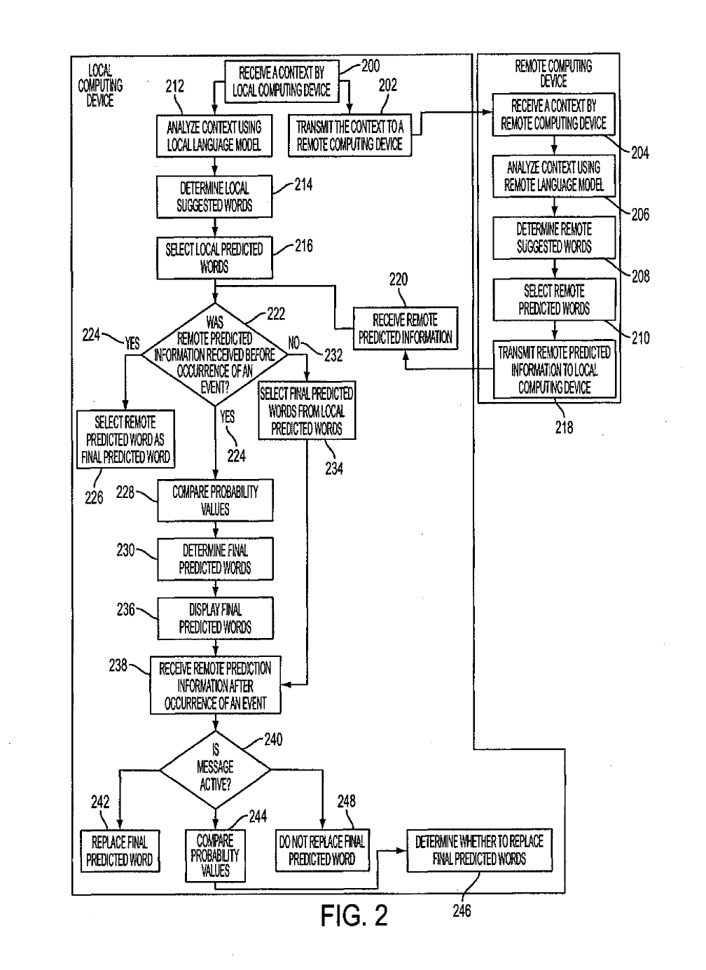

FIG. 2 illustrates a method of predicting one or more words in a message according to an embodiment. As illustrated by FIG. 2, a local computing device may receive 200 a context. A context may include data indicative of one or more characters, words, phrases, sentences and/or the like. A context may be received from a user via an input device of the local computing device. The context may be displayed on a display of the local computing device. Examples of local computing devices include, without limitation, a processor-based device, mobile phones, personal digital assistants, tablet computers, portable computers and similar types of systems and devices.

A local computing device may transmit 202 information that includes at least a portion of a context to a remote computing device. In an embodiment, the information may also include context-related information. Context-related information may include information that may be used in conjunction with a context to predict one or more words.

In an embodiment, context-related information may include a message type or an application associated with a message and/or a context. For example, context-related information may include an indication of whether the message is a text message, an email message, a social network update, a user's preferred language, or the like. In an embodiment, context-related information may include a user identifier associated with the user of a local computing device. The user identifier may be the user's name, an alias, a unique alpha-numeric code or other identifier associated with the user. In an embodiment, a user identifier may be used to locate personalized local and/or remote language models.

In an embodiment, context-related information may include time information. Time information may include information about the time or time-of-day during which a message is being composed. Examples of time information may include a current time, a current day, an indication of whether the current day is a weekday or weekend, an indication of whether a current time is during the morning, afternoon or evening, and/or the like. Time information may relate to the location of a local computing device.

In an embodiment, context-related information may include a location associated with a local computing device. In an embodiment, a location may be determined automatically by a GPS-enabled local computing device. In an embodiment, a user may provide location information.

In an embodiment, the remote computing device may receive 204 at least a portion of a context and/or context-related information from a local computing device. The remote computing device may analyze 206 the context and/or the context-related information using the remote language model and may determine 208 one or more remote suggested words based on the analysis. In an embodiment, one or more of the remote suggested words may be associated with a probability value. A probability value may represent a likelihood that the corresponding remote suggested word is the next word that will be entered.

In an embodiment, one or more probability values may be based at least in part on the context-related information. For example, certain words in the remote language model may have a higher probability of being used in certain types of messages than other types of messages. For example, a word may have a higher probability for text messages than it does for social network posts.

As another example, a probability associated with a word may be based at least in part on the identity of a local computing device user. A remote language model may be a personalized language model associated with a user. Words frequently used by a user may have higher probabilities than words that are not frequently used by the user. In addition, words frequently used by a user may have higher probabilities than the same words in language models associated with other users.

In an embodiment, a probability may be based at least in part on time information in the received context-related information. For example, a user may be more likely to use certain words in the evenings or on weekends than during a weekday. As such, these words may have a higher probability during the evenings or weekends than they do during a weekday. Additional and/or alternate timeframes may be used within the scope of this disclosure.

A probability may be based at least in part on a location of a local computing device. For example, if a user is in a region or country, certain words associated with the region or country may be associated with a higher probability than words not associated with the region or country or than the words when the user is not located in the region or country. These words may be part of a local dialect, slang or other similar terminology. As another example, if a local computing device is located in a popular skiing area, ski-related terms may have greater probabilities than other terms. Additional and/or alternate location associations may be used within the scope of this disclosure. A probability may be based at least in part on any combination of the factors described above and/or other factors.

In an embodiment, a remote computing device may select 210 one or more predicted words from the words that are suggested by the remote computing device. The selection may be based on the probability values associated with the remote suggested words. In an embodiment, a certain number of suggested words having the highest probability values may be selected 210 as predicted words. For example, a remote computing device may select 210 the three suggested words having the highest probability values as predicted words. In an embodiment, one or more suggested words having probability values within a range of values may be selected 210 as predicted words. For example, all suggested words having probability values between 0.80-0.99 may be selected 210 as predicted words. Additional and/or alternate values may be used within the scope of this disclosure.

A local computing device may store a local language model. A local language model may be smaller, less robust and/or less complex than a remote language model. For example, a local language model may include a smaller database of words than a remote language model. As another example, a local language model may include a smaller selection of words or less of a variety of words than a remote language model.

A remote computing device may have more memory or a faster processing speed than a local computing device. For example, if a local computing device is a mobile phone, and a remote computing device is a networked server, the server may have a greater storage capacity and/or processing speed than the mobile phone.

A local computing device may analyze 212 the context using the local language model and may determine 214 one or more suggested words based on the analysis. Each of the one or more suggested words may be associated with a probability value that represents a likelihood that the corresponding suggested word is the next word that will be entered by a user.

In an embodiment, one or more probabilities may be based on context-related information as described above.

In an embodiment, a local computing device may select 216 one or more predicted words from the words suggested by the local computing device. The selection may be based on the probability values associated with the suggested words. In an embodiment, a number of suggested words having the highest probability values may be selected 216 as predicted words. For example, a local computing device may select 216 the three suggested words having the highest probability values as predicted words. In an embodiment, one or more suggested words having probability values within a range of values may be selected 216 as predicted words. For example, all suggested words having probability values between 0.80-0.99 may be selected as predicted words. Additional and/or alternate values may be used within the scope of this disclosure.

In an embodiment, analysis 212 of a context by a local computing device may occur concurrently with the analysis 206 of the context by a remote computing device and communication with the remote computing device. For example, a context including one or more characters may be received by a local computing device. The local computing device may transmit the context to a remote computing device. While the remote computing device is analyzing the context, the remote computing device may analyze the context using a local language model.

In an embodiment, a remote computing device may transmit 218 remote predicted information to a local computing device. In an embodiment, remote predicted information may include one or more words predicted by the remote computing device and corresponding probability values. The local computing device may receive 220 the remote predicted information. In an embodiment, a local computing device may determine 222 whether it received the remote predicted information before the occurrence of an event. In an embodiment, the occurrence of an event may be the expiration of a time period. For example, a local computing device may determine 222 whether it received the remote predicted information within a time period or before the expiration of a time period. The time period may be a time within which a predicted word is to be presented to a user. For example, a time period may be no more than 0.5 seconds. Additional and/or alternate time periods, such as, for example, 0.1 seconds, 0.3 seconds, 0.6 seconds, and 1 second may be used within the scope of this disclosure. A time period may be a setting of a local computing device. In an embodiment, the length of a time period may be adjusted by a user. In an embodiment, the time period may be a time period prior to the user confirming one or more suggested words from the local language model.

In an embodiment, the occurrence of an event may be receiving a subsequent input from a user. For example, the occurrence of an event may be receiving one or more characters of a current word or subsequent word from a user.

If the local computing device receives remote predicted information before the occurrence of an event 224, the local computing device may select 226 one or more of the predicted words from the remote predicted information as final predicted words. In an embodiment, the local computing device may select 226 one or more final predicted words based on the probability values associated with the remote predicted words from the received remote predicted information. For example, a local computing device may select 226 a certain number of final predicted words (e.g., a certain number of final predicted words or a number of words that can be displayed in a view area of a local computing device), and may select 226 the predicted words from the remote predicted information having the highest probability values. For example, a remote computing device may only select 226 one final predicted word, and may select 226 the predicted word from the remote predicted information having the highest probability value as the final predicted word. In an alternate embodiment, a local computing device may select 226 each of the predicted words in the received remote predicted information as final predicted words.

In an embodiment, if a local computing device receives remote predicted information before the occurrence of an event 224, a local computing device may compare 228 one or more probability values associated with received remote predicted words and one or more probability values associated with local predicted words to determine 230 one or more final predicted words. Table 1 illustrates examples of words predicted by a remote computing device and corresponding probability values as well as examples of words predicted by a local computing device and corresponding probability values according to an embodiment.

TABLE 1

| | | Words Predicted | |
|---|---|---|---|
| Words Predicted by | | by Remote | |
| Local Computing | | Computing | Probability |
| Device | Probability Value | Device | Value |
| Chair | 0.02 | Desk | 0.09 |
| Table | 0.15 | Wall | 0.52 |
| Bench | 0.04 | Bed | 0.18 |

A local computing device may select as a final predicted word the word having the highest probability value. For example, referring to Table 1, a local computing device may select “Wall” as a final predicted word because it is associated with the highest probability value of all the words.

In an embodiment, a local computing device may select one or more final predicted words from the words predicted by the remote computing device. The local computing device may select a certain number of final predicted words. For example, the local computing device may select three final predicted words. Additional and/or alternate numbers of final predicted words may be used within the scope of this disclosure.

A local computing device may select a certain number of final predicted words based on the corresponding probability values. For example, a local computing device may select as final predicted words the words predicted by a remote computing device and/or a local computing device having the highest probability values. Referring to Table 1 as an example, a local computing device may select the words “Wall” and “Bed” that were predicted by a remote computing device and the word “Table” that was predicted by a local computing device as the final predicted words because these are the three predicted words having the three highest probability values.

In an embodiment, if a local computing device does not receive remote predicted information before the occurrence of an event 232, the local computing device may select 234 one or more final predicted words from the words predicted by the local computing device. The selection may be based, at least in part, on probability values associated with the words predicted by the local computing device. For example, a local computing device may select 234 a certain number of final predicted words, and may select 234 the words having the highest probability values. For example, a local computing device may only select 234 one final predicted word, and may select 234 the word predicted by the local computing device that has the highest probability value as the final predicted word. In an alternate embodiment, a local computing device may select 234 each of the words predicted by the local computing device as final predicted words.

In an embodiment, a local computing device may filter one or more final predicted words based on input received from the user. For example, a user may have input one or more characters between a time a context is analyzed and a time one or more final predicted words are selected. This input may be used to filter the final predicted words that are displayed to a user. For example, the final predicted words for the context “I am” may include {here, home, coming, OK}. If the user inputs the character ‘h’ after the context is analyzed, the local computing device may filter the final predicted words such that only the words {here, home} are displayed to a user.

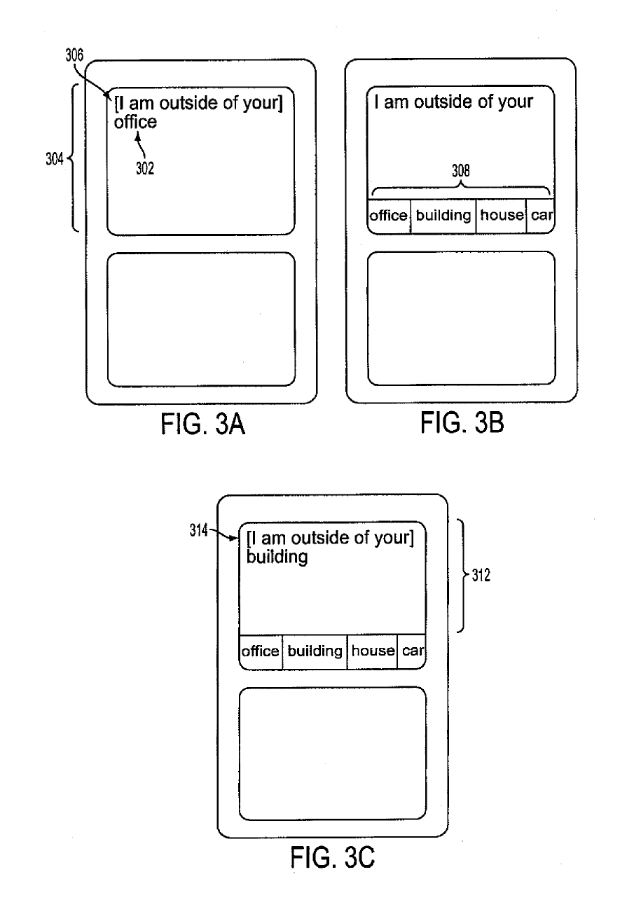

In an embodiment, the one or more final predicted words may be displayed 236 at a local computing device. The one or more final predicted words may be displayed 236 following an associated context. For example, a final predicted word for a context “I am outside of your” may be “office.” The word “office” 302 may be displayed 236 in the message 304 following an associated context 306 as illustrated by FIG. 3A. Final predicted words may be shown in a different style or format than other displayed characters. For example, a final predicted word may blink, may be displayed in a different color, or may be displayed in a different font style. Additional and/or alternate styles or formats may be used within the scope of this disclosure.

In an embodiment, the local computing device may make a prediction, and may send the context to a remote computing device after a prior word is completed. By way of example, a prior word may be deemed completed after a whitespace is received. For example, using the example above, the local computing device may make a prediction and may send the context “I am outside of your” to a remote computing device prior to receiving a user's input for a character of the next word (i.e., the ‘o’ of “office”).

In an embodiment, the one or more final predicted words may be displayed 236 as part of a menu or other list of suggested words. FIG. 3B illustrates an example of a list 308 of suggested words that may be displayed 236 at a local computing device according to an embodiment. In an embodiment, a local computing device may receive a selection of words from the one or more final predicted words from a user. For example, a user may touch the final predicted word or otherwise select a final predicted word using an input device of a local computing device. The local computing device may display the selected final predicted word following the associated context. For example, if the word “building,” as illustrated by FIG. 3C is selected as the final predicted word, it may be displayed in a message 312 following an associated context 314 as illustrated in FIG. 3C.

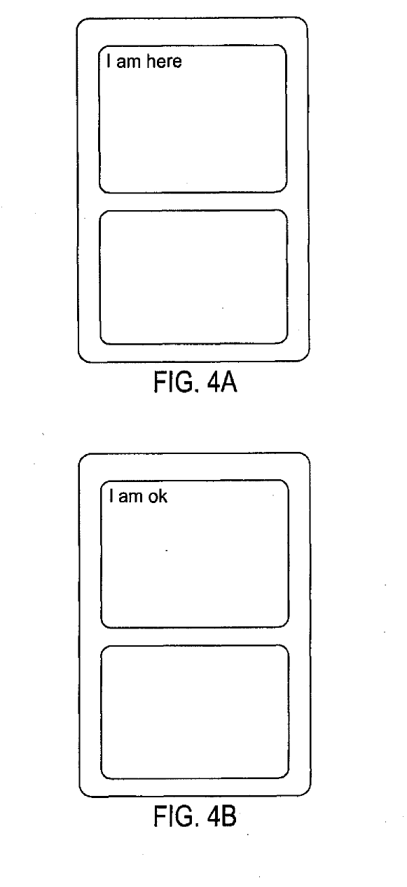

In an embodiment, a local computing device may receive 238 remote predicted information from a remote computing device after the occurrence of an event. If the corresponding message is still active 240, meaning that the message has not been closed, sent or otherwise ended, the local computing device may replace 242 one or more of the final predicted words displayed at the local computing device with one or more of the words from the received remote predicted information. As such, the local computing device may output at a display one or more of the words from the received remote predicted information in place of one or more of the final predicted words. For instance, a local computing device may not receive remote predicted information associated with a context “are you” from a remote computing device within a period of time. The local computing device may select and display a word predicted by the local computing device at the local computing device. For example, as illustrated by FIG. 4A, a local computing device may select and display the word “here.”

The local computing device may receive 238 remote predicted information that includes the word “OK” after the expiration of an event but while the message is still active. As illustrated by FIG. 4B, the local computing device may output the word “OK” in place of the word “here.” In an embodiment, the local computing device may replace 242 one or more final predicted words after providing notification to a user. In an embodiment, the local computing device may replace 242 one or more final predicted words without providing notification to a user.

In an embodiment, a local computing device may compare 244 probability values associated with words predicted by the remote computing device and final predicted words to determine 246 whether to replace one or more final predicted words being displayed. If a word within remote predicted information that is received from a remote computing device after the expiration of a time period is associated with a higher probability value than a probability value associated with a final predicted word that is being displayed, the final predicted word may be replaced by the word within the remote predicted information. For instance, referring to the example above, the final predicted word “here” may have a probability value of 0.82 while the word “OK” may have a probability value of 0.91. The local computing device may replace the word “here” with “OK” because the probability value associated with the word “OK” is higher than the probability value associated with the word “here.” In an embodiment, one or more final predicted words may be supplemented with one or more words provided by the remote predicted information.

In an embodiment, if a word that is received from a remote computing device after the expiration of a time period is associated with lower probability value than a probability value associated with a final predicted word that is being displayed, the final predicted word may not be replaced 248. For example, the word “here” is associated with a probability value of 0.91 and the word “OK” is associated with a probability value of 0.82, the local computing device may not replace the word “here.”

In an embodiment, a method may be represented by the pseudocode in Table 2:

TABLE 2
for each WORD {

- send context to local and remote language models
- receive list of predicted words in given context, along with their

probabilities from local language model

for each input char/tap {

- if (list of predicted words in given context, along with their

probabilities has arrived from remote language model)

combine local and remote LM information

} else {

nothing to combine

}

- filter candidate current words based on chars/taps received from

the user so far, as well as information from local/remote language models

```
  - display suggestions from filtered list for completing the current
  word
```

}

In an embodiment, the methods described above, such as those illustrated by FIG. 1, may be repeated as a local computing device receives additional contexts from a user. For example, the method of FIG. 1 may be repeated for each character, groups of characters, words, sentences and/or the like received by a local computing device. In an embodiment, remote predicted information may be received by a local computing device asynchronously at any time during any repetition of the method.

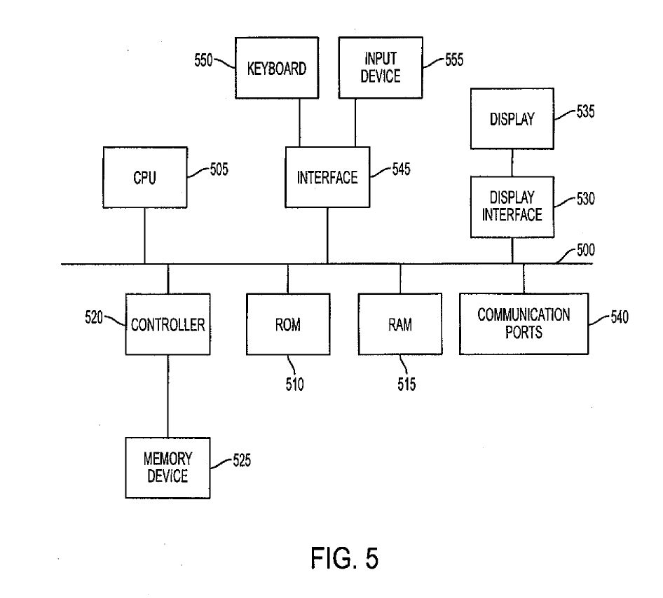

FIG. 5 depicts a block diagram of internal hardware that may be used to contain or implement program instructions according to an embodiment. A bus 500 interconnects the other illustrated components of the hardware. CPU 505 is the central processing unit of the system, performing calculations and logic operations required to execute a program. Read only memory (ROM) 510 and random access memory (RAM) 515 constitute examples of memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices.

One or more programming instructions may be stored in the ROM 510 and/or the RAM 515. Optionally, one or more programming instructions may be stored on a tangible, non-transitory computer readable storage medium such as a hard disk, compact disk, a digital disk, flash memory, a memory card, a USB drive, an optical disc storage medium and/or other recording medium. The one or more programming instructions, when executed, may cause the CPU to perform one or more actions, steps and/or the like. For example, one or more programming instructions, when executed, may cause a CPU to perform one or more steps of the method described above with respect to FIG. 2.

An optional display interface 530 may permit information from the bus 500 to be displayed on the display 535 in audio, visual, graphic or alphanumeric format. Communication with external devices may occur using various communication ports 540. A communication port 540 may interface with a communications network, such as the Internet or an intranet. For example, the communication port may include network functions to communicate on wireless or wired networks, included cellular telecommunications networks, WiFi, and/or wired Ethernet networks.

The hardware may also include an interface 545 which allows for receipt of data from input devices such as a keyboard 550 or other input device 555 such as a mouse, a joystick, a touch screen, a remote control, a stylus, a pointing device, a video input device and/or an audio input device.

An embedded system may optionally be used to perform one, some or all of the operations described herein Likewise, a multiprocessor system may optionally be used to perform one, some or all of the operations described herein.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method comprising:
receiving, at a first computing device, a context indicative of at least part of a written communication;
sending, by the first computing device, to a second computing device, at least part of the context;
determining, by the first computing device, independent of the second computing device, one or more first predicted words based on the context and a local language model, wherein the first predicted words represent candidates for a new word to be inserted in the written communication to advance completion of the written communication;
receiving, by the first computing device, from the second computing device, one or more second predicted words determined based on the context and a remote language model, wherein the second predicted words potentially represent one or more alternatives to the first predicted words;
identifying one or more final predicted words based on the first predicted words and the second predicted words; and
outputting the final predicted words for display.

2. The method of claim 1, wherein:
the context further comprises context-related information comprising one or more of the following:
an identity of an application being used,
an identity of a user of the first computing device,
a location associated with the first computing device when the receiving occurs, and
a time of day associated with the location when the receiving occurs.

3. The method of claim 1, wherein the second computing device is located remotely from the first computing device and the remote language model is more robust than the local language model.

4. The method of claim 1, wherein identifying one or more final predicted words:
from between the first predicted words and the second predicted words is based on a probability value as determined by the language model that predicted each respective predicted word.

5. The method of claim 1, wherein receiving the one or more second predicted words must occur within a time period that does not exceed 0.5 seconds.

6. The method of claim 1, wherein outputting the final predicted words for display comprises one or more of the following:
outputting the final predicted words as candidates for a new word in the written communication; and
outputting the final predicted words as part of a plurality of suggested words.

7. The method of claim 1, further comprising:
receiving, at the first computing device, a second context; and
sending, by the first computing device to the second computing device, at least a part of the second context.

8. The method of claim 1, wherein one or more of the local language model and the remote language model are personalized to a user.

9. A method comprising:
receiving, by a computing device, a context indicative of at least part of a written communication;
sending, by the computing device, at least part of the context to a remote language model and to a local language model, wherein the local language model and the remote language model are configured to return separately one or more predicted words based on a received context;
receiving, by the computing device, one or more predicted words from at least one of the local language model and the remote language model, wherein the one or more predicted words represent candidates for a new word to be inserted in the written communication to advance completion of the written communication; and
displaying at least a subset of the one or more predicted words, wherein the subset excludes words received after an event.

10. The method of claim 9, further comprising:
filtering the subset of the one or more predicted words based on part of the context received by the computing device after the sending occurs.

11. The method of claim 9, wherein the subset excludes words received after an event comprising one or more of the following:
expiration of a time period; and
receiving one or more characters by the computing device, after the sending occurs.

12. The method of claim 11, wherein the time period does not exceed 0.5 seconds.

13. The method of claim 9, wherein the subset comprises a single word.

14. The method of claim 9, wherein the subset comprises at least two words, wherein the computing device comprises a user interface configured to detect a selection of a word from the at least two displayed words.

15. The method of claim 9, wherein displaying the subset of the one or more predicted words comprises:
displaying one or more predicted words received from the local language model prior to receiving a response from the remote language model; and
displaying one or more predicted words received from the remote language model provided that the one or more predicted words from the remote language model are received prior to an event such as expiration of a time period.

16. The method of claim 9, further comprising:
outputting a predicted word received by the computing device from the remote language model in place of a predicted word received from the local language model if the predicted word received from the remote language model is received by the computing device before an event and a second probability value associated with the predicted word received from the remote language model exceeds a probability value associated with the predicted word received from the local language model.

17. The method of claim 9, wherein the remote language model is more robust than the local language model and is located remotely from the computing device.

18. The method of claim 9, wherein one or more of the local language model and the remote language model are personalized at least in part on an identity of a user.

19. A method comprising:
receiving, by a mobile computing device, a context indicative of at least part of a written communication;
sending, by the mobile computing device to a server, at least part a portion of the context;
analyzing, by one or more processors of the mobile computing device, the context using a first language model to provide a first set of predicted words based on the context, the first set of predicted words represent candidates for a new word to be inserted in the written communication to advance completion of the written communication;
displaying the first set of predicted words;
receiving, at the mobile computing device, a second set of predicted words from the server, wherein the second set of predicted words potentially comprises one or more alternatives to the first set of predicted words, the second set of predicted words are provided by a second language model used by the server to predict words based on the context sent by the mobile device; and
displaying the second set of words.

20. The method of claim 19, wherein receiving a second set of predicted words from the server comprises receiving a second set of predicted words from the server prior to expiration of a time period.

21. The method of claim 19, wherein receiving a second set of predicted words from the server comprises receiving a second set of predicted words from the server prior to an occurrence of an event.

22. The method of claim 21, wherein the event comprises receiving, by the mobile computing device, an inputed character.

23. The method of claim 19, wherein receiving a second set of predicted words from the server comprises receiving a probability value for each word of the second set of predicted words, wherein at least one word of the second set of predicted words is associated with a probability value greater than any word in the first set of predicted words.

24. The method of claim 19, wherein sending at least part of the context comprises sending at least two words that were most recently received by the mobile computing device.

25. The method of claim 19, wherein the second language model is more robust than the first language model.

26. A system comprising:
a processor;
a communication interface in communication with the processor; and
a processor-readable storage medium in communication with the processor and the communication interface, wherein the processor-readable storage medium comprises one or more programming instructions that, when executed, cause the processor to:
receive a context comprising data that is indicative of at least part of a written communication,
send at least a part of the context via the communication interface,
determine a first predicted word based on the context and a local language model, wherein the first predicted word represents a candidate for a new word to be inserted in the written communication to advance completion of the written communication,
receive a second predicted word determined based on the context and a remote language model, wherein the second predicted word potentially represents an alternative to the first predicted word,
identify one of the first predicted word and the second predicted word as a final predicted word, and
output the final predicted word for display.

27. The system of claim 26, wherein the one or more programming instructions that, when executed, cause the processor to send at least part of the context comprise one or more programming instructions that, when executed, cause the processor to send at least part of the context to a computing device located remotely from the processor, wherein the remote language model is more robust than the local language model.

28. The system of claim 26, further comprising one or more programming instructions that, when executed, cause the processor to analyze the context using the local language model, wherein the local language model is stored in a non-transitory computer-readable storage medium located at the processor.

29. The system of claim 26, further comprising one or more programming instructions that, when executed, cause the processor to identify from between the first predicted word and the second predicted word having a greater probability value as determined by the language model that predicted each respective word.

30. The system of claim 26, wherein the one or more programming instructions that, when executed, cause the processor to output the final predicted word for display comprise one or more programming instructions that, when executed, cause the processor to perform one or more of the following:
output the final predicted word following the context for display; and
output the final predicted word as part of a plurality of suggested words.

31. The method of claim 4, wherein the probability value is based, at least in part, on time information comprising a time of day and a day of a week.

32. The method of claim 9, wherein the context comprises time information including a time of day and a day of a week.

33. The method of claim 19, wherein the context comprises time information including a time of day and a day of a week.

34. The system of claim 26, wherein the context comprises time information including a time of day and a day of a week.

35. The method of claim 1, wherein the final predicted words comprise at least one word from the first predicted words and at least one word from the second predicted words.
